(19) United States
(12) Patent Application Publication
(10) Pub. No.: US 2008/0309827 A1
(43) Pub. Date: Dec. 18, 2008

(54) Filter Device, Circuit Arrangement Comprising Such Filter Device as Well as Method of Operating Such Filter Device

(75) Inventor: Axel Kattner, Seevetal (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/909,433

(22) PCT Filed: Mar. 20, 2006
(86) PCT No.: PCT/IB2006/050842

§ 371 Date: Aug. 14, 2008

(30) Foreign Application Priority Data
Mar. 21, 2005 (EP) 05102214.3

(51) Int. Cl. H04N 5/62; H04N 5/60

(52) U.S. Cl. 348/731; 348/E05.122

(57) ABSTRACT

In order to provide a filter device (50, 60) as well as a method for processing input signals, in particular I[ntermediate]F[requency] input signals, for example sound signals, such as received television signals, wherein a bandpass function around the desired carriers is provided and the sound demodulation performance is not disturbed, at least one passive polyphase filter stage (50) being designed for image rejection and at least one active polyphase filter stage (60) being combined with the passive polyphase filter stage (50) and being designed for band pass as well as for contributing to the image rejection in order to relax the attenuation requirements of the passive polyphase filter stage (50) are proposed.

The present invention relates to a filter device for processing input signals, in particular I[ntermediate]F[requency] input signals, for example sound signals, such as received television signals.

The present invention further relates to an electric or electronic circuit arrangement, in particular to a sound processing path, comprising
at least one surface acoustic wave filter stage, in particular at least one external window surface acoustic wave filter,
at least one amplifier stage for amplifying the output signal of the surface acoustic wave filter stage,
at least one inphase/quadrature mixer stage for processing the output signal of the amplifier stage, in particular for mixing the amplified sound I[ntermediate]F[requency] input signal down to the lower frequency by means of the output signal of at least one voltage controlled oscillator stage.

The present invention further relates to a method for processing input signals, in particular I[ntermediate]F[requency] input signals, for example sound signals, such as received television signals.

T[ele]V[ision] transmission is performed in multi channels, which can be adjacent (for example for cable transmission). For reception the desired channel has to be separated from the undesired adjacent channels (so-called channel selectivity). Furthermore for demodulation single carriers have to be separated from other carriers within the desired channel (so-called carrier selectivity).

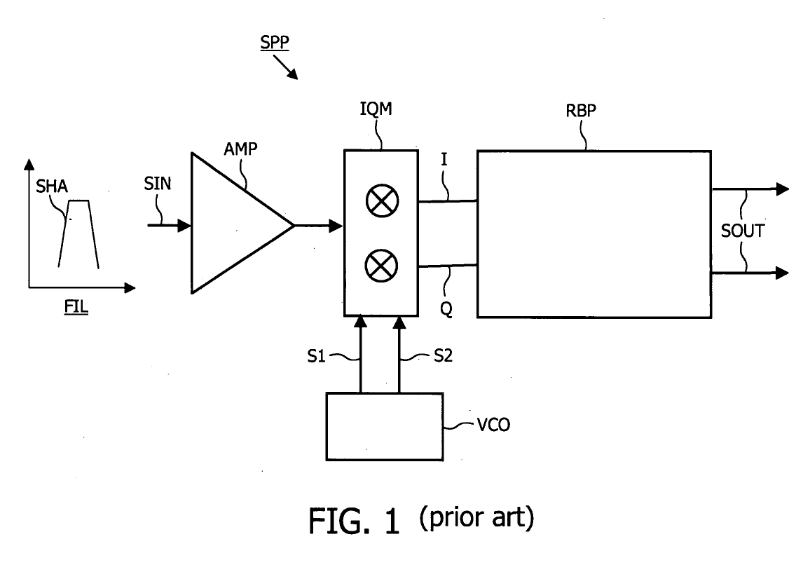

In older concepts the selectivity of carriers is mainly done by external S[urface]A[coustic]W[ave] filters (reference numeral FIL in FIG. 1) with adapted shape SHA. In this context, FIG. 1 shows a sound processing path SPP according to the prior art wherein an external window surface acoustic wave filter FIL selects the desired channel.

The whole (analog) TV signal SIN is amplified by an amplifier AMP and fed to an I[nphase/]Q[uadrature] mixer IQM. This mixer IQM
receives a VCO signal S1, S2 from a voltage controlled oscillator VCO, the VCO signal S1, S2 comprising—
a first component S1 with a vanishing phaseshift (zero degree) and
a second component S2 with a phaseshift of ninety degree, and
mixes the amplified sound I[ntermediate]F[requency] input signal SIN down to the lower frequency.

As also shown in FIG. 1, a low pass filter or real band pass filter RBP attenuates the picture signals of the received channel (picture carrier PC, colour carrier CC) as well as the lower adjacent channel signals, especially the picture carrier PC_{N-1}.

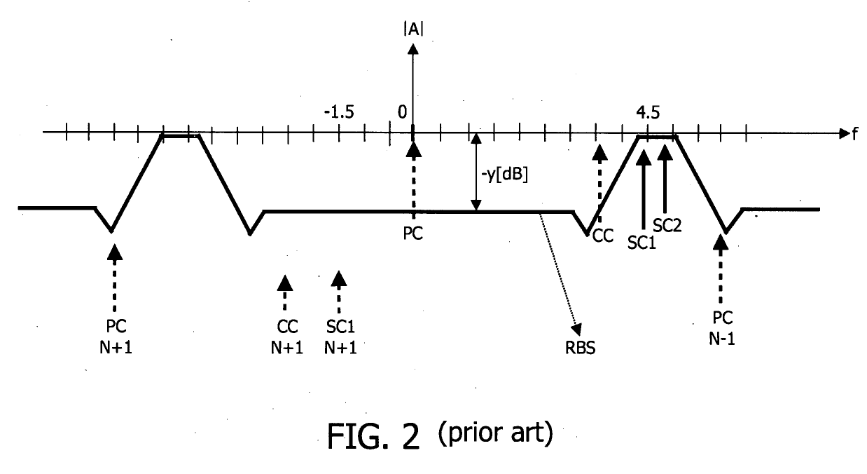

FIG. 2 shows the frequency situation of the sound carriers as well as of some frequency components according to the prior art. The desired sound carriers SC1, SC2 have the second sound intermediate frequencies (for N[ational]T[elevision]S[ystems]C[ommitee] 4.5 M[ega]H[ert]z, 4.74 M[ega] H[ert] z respectively).

Since the selectivity of carriers is mainly done by the external S[urface]A[coustic]W[ave] filter FIL a large variety of SAW filters is necessary for multistandard application in the prior art (low pass filter selectivity or real band pass filter selectivity with reference numeral RBS; cf. FIG. 2).

Known current concepts for multistandard T[ele]V[ision] signal reception try to reduce the number of needed surface acoustic wave filters. To cover all possible TV standards including digital TV, two window SAW filters are used, one comprising a bandwidth of six M[ega]H[ert]z, and the other comprising a bandwidth of eight M[ega]H[ert]z.

However, in these prior art concepts image rejection with partly high requirements is needed to suppress adjacent channels; in this context, the channel selectivity is tried to be done by integration as much as possible.

Looking for analog TV sound processing in such prior art concepts shows that the second sound intermediate frequency carriers of the TV signal are surrounded
on the lower frequency side by the picture carrier PC as well as
by the colour carrier CC of the desired band and
on the higher frequency side
by the picture carrier PC of the adjacent channel as well as
by higher order harmonics of the I[nphase/]Q[uadrature] mixer IQM.

All frequency components are undesired and disturb the sound demodulation performance. A bandpass function around the desired sound carriers at TV standard dependent frequencies is necessary.

In this context, the basic principle of tuning and frequency switching of filters is known; also the basic principle of complex filtering or polyphase filtering is disclosed in prior art document U.S. Pat. No. 6,377,315 B1 referring to a polyphase filter output fed to a bandpass filter.

In this prior art document U.S. Pat. No. 6,377,315 B1, a polyphase circuit stage is used as a (supposedly passive) polyphase filter so as to provide image rejection. Besides, two real band pass filters are provided wherein one of these band pass filters is assigned to the I[nphase] path and the other of these band pass filters is assigned to the Q[uadrature] path. However, an active controlled polyphase filter is not revealed.

In the prior art article “A 900-MHz Dual-Conversion Low-IF GSM Receiver in 0.35-μm CMOS” by Shahrzad Tadjpour et al., IEEE Journal Of Solid State Circuits, Vol. 36, No. 12, December 2001, a system referring to the technological background of the present invention and being provided with two cascaded polyphase filters (=a passive polyphase filter and an active polyphase filter) with mixers and amplifiers is disclosed; between these two polyphase filters, the frequency situation is changed once by mixing; the passive polyphase filter provides the image rejection for the subsequent mixing, the active polyphase filter is switchable.

In prior art document U.S. Pat. No. 6,236,847 B1, two passive polyphase filters are used in tandem for achieving adjacent selectivity and image rejection; by this prior art document U.S. Pat. No. 6,236,847 B1, the technique of passive polyphase filtering is presented wherein two passive polyphase filters respectively suppress the negative frequency range; frequency mixing is necessary between these two passive polyphase filters in order to maintain a band pass characteristic; the resulting passing range is dependent on the input frequency. Since more than one channel passes there is no narrow-band channel selectivity and especially no carrier selectivity.

Starting from the disadvantages and shortcomings as described above and taking the prior art as discussed into account, an object of the present invention is to further develop a filter device of the kind as described in the technical field, a circuit arrangement of the kind as described in the technical field as well as a method of the kind as described in the technical field in such way that a bandpass function around the desired carriers is provided and that the sound demodulation performance is not disturbed.

The object of the present invention is achieved by a filter device comprising the features of claim 1, by a circuit arrangement comprising the features of claim 5 as well as by a method comprising the features of claim 8. Advantageous embodiments and expedient improvements of the present invention are disclosed in the respective dependent claims.

The present invention is principally based on the idea of combining at least two polyphase filters for integrated channel and carrier selectivity wherein
at least one of said polyphase filters is a passive polyphase filter and
at least one of said polyphase filters is an active polyphase filter, in particular of the same frequency situation.

In this context, the at least one passive polyphase filter stage is designed for image rejection, and the at least one active polyphase filter stage is designed for band pass as well as for contributing to the image rejection in order to relax the attenuation requirements of the passive polyphase filter stage.

Thus, the active polyphase filter facilitates and/or supports the I[mage]R[ejection] specification of the passive polyphase filter (without this facilitation and/or support, the I[mage]R[ejection] would have to be realized solely by the passive polyphase filter); in other words, the active polyphase filter stage additionally provides image rejection.

By utilizing polyphase filtering, an optimal signal-to-noise ratio is obtained; negative frequencies do not contribute noise.

According to a preferred embodiment of the present invention, the at least one passive polyphase filter and the at least one active polyphase filter, the latter filter in particular being embodied as at least one active polyphase band pass filter, are cascaded in such way
that the band pass function around at least one defined or desired carrier frequency is provided,
that the sound demodulation performance is not disturbed, and
that an optimal signal-to-noise ratio is obtained.

According to an expedient embodiment of the present invention, the active polyphase band pass filter is designed
to select the sound signals within at least one composite video signal, in particular to relax the attenuation requirements of the previous passive polyphase filter stage, and/or
to reduce the undesired picture signals (picture carrier PC, colour carrier CC) as well as the neighbour channel signals (PC, CC, S[ound]C[arrier] (N+1)/(N−1)).

Regarding the advantages of the present invention, there is small integration effort by splitting the needed image rejection requirement into two (or more) filters, namely into
at least one first (passive) polyphase filter for image rejection only but with reduced requirements and
at least one second (active) polyphase filter introducing a band pass characteristic for the sound signals and additionally contributing to the image rejection; in this context, the polyphase band pass filter relaxes the attenuation requirements of a previous image rejection filter because it contributes image rejection as well.

By the implementation according to the present invention, the application effort (four external ceramic band pass filters) is reduced by integrating one (or more) standard dependent switched filter; independently thereof or in connection therewith, only a small area is required for the integration by a standard dependent switched and tuned integrated band pass filter.

Using the present invention allows an equal band pass characteristic over a large frequency range whereas a real band pass would change the steepness of the sidewalls by tuning the frequency.

According to the method of the present invention, input signals, in particular l[ntermediate]F[requency] input signals, for example sound signals, such as received television signals, are processed by
image rejecting by means of at least one passive polyphase filter stage and
band passing by means of at least one active polyphase filter stage,

said active polyphase filter stage being combined, in particular cascaded, with said passive polyphase filter stage.

Moreover, according to a preferred embodiment of the method according to the present invention,
the band pass function is provided around at least one defined or desired carrier frequency,
the sound demodulation performance is not disturbed, and
an optimal signal-to-noise ratio is obtained.

The present invention can be used for channel selectivity and especially for sound processing in any analog I[ntegrated]C[ircuit] for T[ele]V[ision] signal handling including I[ntermediate]F[requency] processing with I[nphase/]Q[uadrature] mixing or internal generating I[nphase/]Q[uadrature] signals; the present invention can for example be used in an alignment-free multistandard (P[hase]A[lternating]L[ine], SE[quentiel]C[ouleur]A[vec]M[émoire], and N[ational]T[elevision]S[tandards]C[ommittee]) vision and sound l[ntermediate]F[requency] signal P[hase-]L[ocked]L[oop] demodulator for positive and negative modulation, including sound A[mplitude]M[odulation] and F[requency]M[odulation] processing.

The present invention finally relates to the use of at least one filter device as described above and/or of at least one circuit arrangement as described above and/or of the method as described above in at least one semiconductor-based audio tuner and/or video tuner signal application, for example in at least one integrated R[adio]F[requency] signal processing front end module, such as in at least one computer monitor, in at least one P[ersonal]C[computer], in at least one S[et-]T[op-]IB[ox], in at least one T[ele]V[ision] set, in at least one V[ideo]C[assette]R[ecorder] and/or in at least one V[ideo]T[ape]R[ecorder].

As already discussed above, there are several options to embody as well as to improve the teaching of the present invention in an advantageous manner. To this aim, reference is made to the claims respectively dependent on claim 1, on claim 5 and on claim 8; further improvements, features and advantages of the present invention are explained below in more detail with reference to a preferred embodiment by way of example and to the accompanying drawings where FIG. 1 schematically shows a block diagram of an embodiment of a circuit arrangement, in particular of a sound processing path, according to the prior art;

FIG. 2 schematically shows a diagram of the amplitude versus the frequency of the carriers and frequency response according to the prior art;

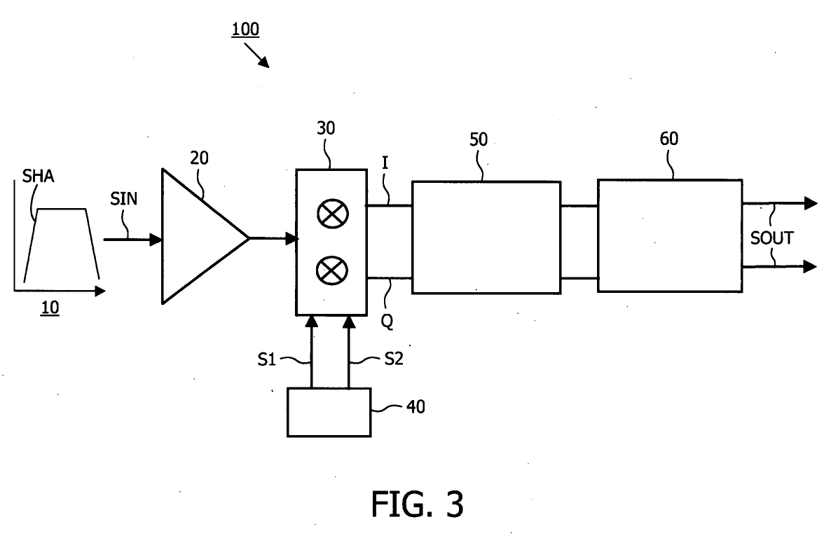

FIG. 3 schematically shows a block diagram of an embodiment of a circuit arrangement, in particular of a sound processing path comprising an embodiment of a filter device, according to the present invention working in compliance with the method of the present invention;

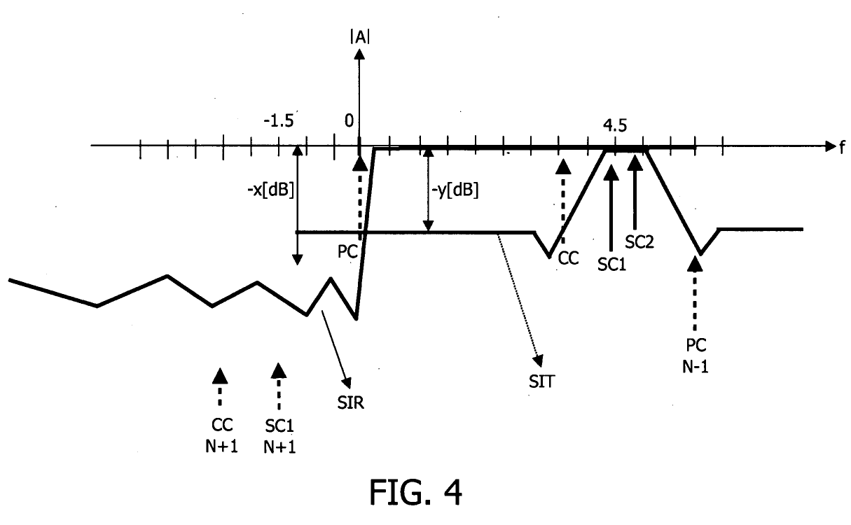

FIG. 4 schematically shows a diagram of the amplitude versus the frequency of the carriers and frequency response according to the present invention; and

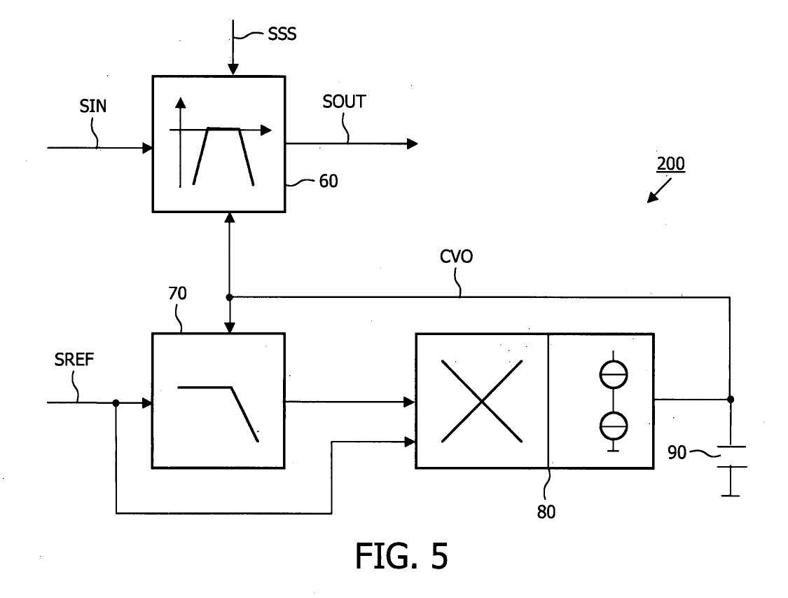

FIG. 5 schematically shows a block diagram of an embodiment of a switchable and tunable polyphase filter controlled by a control loop according to the present invention working in compliance with the method of the present invention.

The same reference numerals are used for corresponding parts in FIG. 1 to FIG. 5.

As discussed above, known current T[ele]V[ision] I[nterrnediate]F[requency] concepts reduce the external selectivity of various S[urface]A[coustic]W[ave] filters with specific characteristic to the use of window SAW filters with two different bandwidths. The depicted new proposal replaces the leak in selectivity by the combination of a passive polyphase filter 50 for image rejection, i.e. providing the image rejection selectivity SIR (cf. FIG. 4) with an active tuned polyphase filter 60 to reach the required channel and carrier selectivity for demodulation and for decoding (—>selectivity by integrated tracking band pass filter with reference numeral SIT; cf. FIG. 4).

In other words, for improved channel selectivity and easier realization, smaller area, easier application, optimal signal-to-noise ratio and even performance over a large frequency range, for instance, for analog sound processing in TV receivers, the passive polyphase filter 50 and the active tuned polyphase bandpass filter 60 are cascaded.

In more detail, FIG. 3 shows the sound processing path 100 according to the present invention wherein an external window surface acoustic wave filter 10 selects the desired channel.

The whole (analog) TV signal SIN is amplified by an amplifier 20 and fed to an I[nphase/]Q[uadrature] mixer 30. This mixer 30
receives a VCO signal S1, S2 from a voltage controlled oscillator 40, the VCO signal S1, S2 comprising
a first component S1 with a vanishing phaseshift (zero degree) and
a second component S2 with a phaseshift of ninety degree, and
mixes the amplified sound I[ntermediate]F[requency] input signal SIN down to the lower frequency.

FIG. 4 shows the frequency situation of the desired carriers and of some undesired carriers, i.e. of the sound carriers as well as of some frequency response. The desired sound carriers SC1, SC2 have the second sound intermediate frequencies (for N[ational]T[elevision]S[ystems]C[ommitee] 4.5 M [ega]H[ert]z, 4.74 M[ega] H[ert]z respectively).

As shown in FIGS. 3 and 4, the I[mage]R[ejection]F[ilter] or passive polyphase filter 50 suppresses the higher adjacent channel N+1. Additionally, the active tuned P[oly]P[hase]B[and]P[as] filter 60 is introduced in order to select the sound carriers SC1, SC2 of the desired channel.

Like a real band pass, the poly phase band pass 60 attenuates the picture signals of the received channel P[icture]C[arrier], C[olour]C[arrier] and the lower adjacent channel signals, especially the picture carrier PC_{N-1}. But furthermore the poly phase band pass 60 gives full contribution to image suppression, i.e. the required image suppression z[dB] is shared
by the image rejection filter 50
(—>first part x[dB] of the required image suppression z[dB]) and
by the poly phase band pass filter 60
(—>second part x[dB] of the required image suppression z[dB]) with z[dB]=x[dB]+y[dB]; this sharing relaxes the internal effort of the image rejection filter 50 (less zeros necessary).

In order to handle the process spread, the temperature dependency and the voltage dependency and so as to reach a high frequency accuracy for the band pass, the active polyphase band pass filter 60 is tuned by a control loop 200 as shown in FIG. 5 and switchable to be able to fit for the various T[ele]V[ision] standards (MN, BG, I, DK and L/L′) with their different second sound intermediate frequencies (4.5 M[ega]H[ert]z/5.5 MHz/6.0 MHz/6.5 MHz/6.5 MHz respectively for the first sound carrier).

In other words, the polyphase bandpass filter 60 is a tuned filter in order to reduce the effects of the process spread, the temperature dependency and the voltage dependency with a control loop 200 as in FIG. 5. The bandpass filter 60 is also switchable to match the various carrier frequencies.

In more detail, FIG. 5 shows a phase detector 80 receiving a reference signal SREF directly and via a reference filter 70. The reference filter 70 shifts the phase of the reference signal SREF by a nominal value. The phase detector 80 compares the original phase of the reference signal SREF with the shifted phase of the reference signal SREF and generates a source output current or sink output current SOC which is stored in a capacitor 90 and gives a control voltage CVO.

This control voltage CVO is used to tune the reference filter 70 to the desired frequency for which it shifts the phase of the reference signal SREF in the way that the control loop 200 is in steady state. The control voltage CVO is additionally used to control the polyphase bandpass filter 60, which matches to the reference filter 70.

For switching the band pass to various carrier frequencies the polyphase bandpass filter 60 gets a standard switch input signal SSS effecting the internal impedance level and thereby changing the filter mid frequency.

### LIST OF REFERENCE NUMERALS

100 circuit arrangement, in particular sound processing path
10 external window surface acoustic wave filter
20 amplifier
30 inphase/quadrature mixer
40 voltage controlled oscillator
50 image rejection filter and/or passive polyphase filter
60 tuned bandpass filter and/or active polyphase filter
70 reference filter
80 phase detector
90 capacitor
200 control loop
A amplitude, in particular signal amplitude
AMP amplifier (=prior art; cf. FIG. 1)
CC colour carrier
CVO control voltage
f frequency
FIL external window surface acoustic wave filter (=prior art; cf. FIG. 1)
I inphase
IQM inphase/quadrature mixer (=prior art; cf. FIG. 1)
N+1 higher adjacent channel
PC picture carrier
Q quadrature
RBP low pass filter or real band pass filter (=prior art; cf. FIG. 1)
RBS low pass filter selectivity or real band pass filter selectivity (=prior art; cf. FIG. 2)
SC1 first desired sound carrier
SC2 second desired sound carrier
SHA adapted shape of surface acoustic wave filter
SIN I[ntermediate]F[requency] input signal, in particular analog I[ntermediate]F[requency] input signal
SIR image rejection selectivity
SIT selectivity by integrated tracking band pass filter
SOC source output current or sink output current
SOUT output signal
SPP circuit arrangement, in particular sound processing path (=prior art; cf. FIG. 1)
SREF reference signal
SSS standard switch input signal
S1 first signal coming from voltage controlled oscillator VCO and comprising vanishing phaseshift (zero degree)
S2 second signal coming from voltage controlled oscillator VCO and comprising phaseshift of ninety degree
VCO voltage controlled oscillator (=prior art; cf. FIG. 1)
x[dB] first part of required image suppression z[dB]
y[dB] second part of required image suppression z[dB]
z[dB] required image suppression (z[dB]=x[dB]+y[dB])

1. A filter device (50, 60) for processing input signals, characterized by
at least one passive polyphase filter stage (50) being designed for image rejection, and
at least one active polyphase filter stage (60)
being combined with the passive polyphase filter stage (50) and
being designed
for band pass as well as
for contributing to the image rejection in order to relax the attenuation requirements of the passive polyphase filter stage (50).

2. The filter device according to claim 1, characterized in that the passive polyphase filter stage (50) and the active polyphase filter stage (60) are cascaded in such way
that the band pass function around at least one defined or desired carrier frequency is provided,
that the sound demodulation performance is not disturbed, and
that an optimal signal-to-noise ratio is obtained.

3. The filter device according to claim 1 or 2, characterized in that the active polyphase filter stage (60) is designed for selecting the sound signals within at least one composite video signal.

4. The filter device according to at least one of claims 1 to 3, characterized in that the active polyphase filter stage or band pass (60) is switched to various carrier frequencies by means of at least one switch input signal (SSS) effecting the internal impedance level and thereby changing the filter mid frequency.

5. An electric or electronic circuit arrangement (100) comprising
at least one surface acoustic wave filter stage (10),
at least one amplifier stage (20) for amplifying the output signal (SIN) of the surface acoustic wave filter stage (10),
at least one inphase/quadrature mixer stage (30) for processing the output signal of the amplifier stage (20),
characterized by
providing the filter device (50, 60) according to at least one of claims 1 to 4 with the output signal (I, Q) of the inphase/quadrature mixer stage (30).

6. The circuit arrangement according to claim 5, characterized by at least one control loop (200) for tuning the active polyphase filter stage (60).

7. The circuit arrangement according to claim 6, characterized in that the control loop (200) comprises
at least one reference filter stage (70) being provided with at least one reference signal (SREF),
at least one phase detector stage (80) being provided with the reference signal (SREF) as well as with the output signal of the reference filter stage (70),
at least one capacitor stage (90)
being provided with the output signal of the phase detector stage (80) and
providing a control voltage (CVO) to the active polyphase filter stage (60) as well as to the reference filter stage (70).

8. A method for processing input signals,
characterized by
image rejecting by means of at least one passive polyphase filter stage (50), and
band passing by means of at least one active polyphase filter stage (60),
said active polyphase filter stage (60) being combined with said passive polyphase filter stage (50).

9. The method according to claim 8, characterized by
providing the band pass function around at least one defined or desired carrier frequency,
not disturbing the sound demodulation performance, and
obtaining an optimal signal-to-noise ratio.

10. The method according to claim 8 or 9, characterized in that the band pass of the active polyphase filter stage (60) is switched to various carrier frequencies by means of at least one switch input signal (SSS) effecting the internal impedance level and thereby changing the filter mid frequency.

11. Use of at least one filter device (50, 60) according to at least one of claims 1 to 4 and/or of at least one circuit arrangement (100) according to at least one of claims 5 to 7 and/or of the method according to at least one of claims 8 to 10 in at least one semiconductor-based audio tuner and/or video tuner signal application.
